(19) United States
(12) Patent Application Publication
(10) Pub. No.: US 2020/0192842 A1
(43) Pub. Date: Jun. 18, 2020

(54) MEMORY REQUEST CHAINING ON BUS

(71) Applicants: ATI Technologies ULC, Markham (CA); Advanced Micro Devices, Inc., Santa Clara, CA (US)

(72) Inventors: Philip Ng, Toronto (CA); Vydhyanathan Kalyanasundharam, Sunnyvale, CA (US)

(73) Assignees: ATI Technologies ULC, Markham (CA); Advanced Micro Devices, Inc., Santa Clara, CA (US)

(21) Appl. No.: 16/221,163

(22) Filed: Dec. 14, 2018

(51) Int. Cl. G06F 13/36; G06F 13/16; G06F 13/40; G06F 13/42

(52) U.S. Cl. CPC G06F 13/36; G06F 13/1615; G06F 13/4221; G06F 13/4045; G06F 13/4022

(57) ABSTRACT

Bus protocol features are provided for chaining memory access requests on a high speed interconnect bus, allowing for reduced signaling overhead. Multiple memory request messages are received over a bus. A first message has a source identifier, a target identifier, a first address, and first payload data. The first payload data is stored in a memory at locations indicated by the first address. Within a selected second one of the request messages, a chaining indicator is received associated with the first request message and second payload data. The second request message does not include an address. Based on the chaining indicator, a second address for which memory access is requested is calculated based on the first address. The second payload data is stored in the memory at locations indicated by the second address.

### BACKGROUND

System interconnect bus standards provide for communication between different elements on a circuit board, a multi-chip module, a server node, or in some cases an entire server rack or a networked system. For example, the popular Peripheral Component Interconnect Express (PCIe or PCI Express) computer expansion bus is a high-speed serial expansion bus providing interconnection between elements on a motherboard, and connection to expansion cards. Improved system interconnect standards are needed for multi-processor systems, and especially systems in which multiple processors on different chips interconnect and share memory.

The serial communication lanes used on many system interconnect busses do not provide a separate path for address information as a dedicated memory bus would do. Thus, to send memory access requests over such busses requires sending both the address and data associated with the request in serial format. Transmitting address information in this way adds a significant overhead to the serial communication links.

### BRIEF DESCRIPTION OF THE DRAWINGS

FIG. 1 illustrates in block diagram form a data processing platform connected in an exemplary topology for CCIX applications.

FIG. 2 illustrates in block diagram form a data processing platform connected in another exemplary topology for CCIX applications.

FIG. 3 illustrates in block diagram form a data processing platform connected in a more complex exemplary topology for CCIX applications.

FIG. 4 illustrates in block diagram from a data processing platform according to another exemplary topology for CCIX applications.

FIG. 5 illustrates in block diagram from a design of an exemplary data processing platform configured according to the topology of FIG. 2 according to some embodiments.

FIG. 6 shows in block diagram form a packet structure for chained memory request messages according to some embodiments.

FIG. 7 shows in flow diagram form a process for fulfilling chained memory write requests according to some embodiments.

FIG. 8 shows in flow diagram form a process for fulfilling chained memory read requests according to some embodiments.

In the following description, the use of the same reference numerals in different drawings indicates similar or identical items. Unless otherwise noted, the word “coupled” and its associated verb forms include both direct connection and indirect electrical connection by means known in the art, and unless otherwise noted any description of direct connection implies alternate embodiments using suitable forms of indirect electrical connection as well.

### DETAILED DESCRIPTION OF ILLUSTRATIVE EMBODIMENTS

An apparatus includes a memory with at least one memory chip, a memory controller connected to the memory and a bus interface circuit connected to the memory controller which sends and receives data on a data bus. The memory controller and bus interface circuit together act to perform a process including receiving a plurality of request messages over the data bus. Within a selected first one of the request messages, a source identifier, a target identifier, a first address for which memory access is requested, and first payload data are received. The process includes storing the first payload data in a memory at locations indicated by the first address. Within a selected second one of the request messages, the process receives a chaining indicator associated with the first request message, and second payload data, the second request message including no address for which memory access is requested. Based on the chaining indicator, the process calculates a second address for which memory access is requested based on the first address. The process then stores the second payload data in the memory at locations indicated by the second address.

A method includes receiving a plurality of request messages over a data bus. Under control of a bus interface circuit, the method includes receiving a source identifier, a target identifier, a first address for which memory access is requested, and first payload data within a selected first one of the request messages. The first payload data is stored in a memory at locations indicated by the first address. Within a selected second one of the request messages, a chaining indicator is received associated with the first request message and second payload data, the second request message including no address for which memory access is requested. Based on the chaining indicator, a second address for which memory access is requested is calculated based on the first address. The method stores the second payload data in the memory at locations indicated by the second address.

A method includes receiving a plurality of request messages over a data bus, under control of a bus interface circuit, within a selected first one of the request messages, receiving a source identifier, a target identifier, and a first address for which memory access is requested. Under control of the bus interface circuit, a reply message is transmitted containing first payload data from locations in a memory indicated by the first address. Within a selected second one of the request messages, a chaining indicator is received associated with the first request message, the second request message including no address for which memory access is requested. Based on the chaining indicator, a second address for which memory access is requested is calculated based on the first address. The method transmits a second reply message containing second payload data from locations in the memory indicated by the second address.

A system includes a memory module having a memory with at least one memory chip, a memory controller connected to the memory, and a bus interface circuit connected to the memory controller and adapted to send and receive data on a bus. The memory controller and bus interface circuit together act to perform a process including receiving a plurality of request messages over the data bus. Within a selected first one of the request messages, the process receives a source identifier, a target identifier, a first address for which memory access is requested, and first payload data. The process includes storing the first payload data in a memory at locations indicated by the first address. Within a selected second one of the request messages, a chaining indicator is received associated with the first request message, and second payload data, the second request message including no address for which memory access is requested. Based on the chaining indicator, a second address is calculated for which memory access is requested based on the first address. The process then stores the second payload data in the memory at locations indicated by the second address. The system also includes a processor with a second bus interface circuit connected to the bus, which sends the request messages over the data bus and receives responses.

FIG. 1 illustrates in block diagram form a data processing platform 100 connected in an exemplary topology for Cache Coherent Interconnect for Accelerators (CCIX) applications. A host processor 110 (“host processor,” “host”) is connected using the CCIX protocol to an accelerator module 120, which includes a CCIX accelerator and an attached memory on the same device. The CCIX protocol is found in CCIX Base Specification 1.0 published by CCIX Consortium, Inc., and in later versions of the standard. The standard provides a CCIX link which enables hardware-based cache coherence, which is extended to accelerators and storage adapters. In addition to cache memory, CCIX enables expansion of the system memory to include CCIX device expansion memory. The CCIX architecture allows multiple processors to access system memory as a single pool. Such pools may become quite large as processing capacity increases, requiring the memory pool to hold application data for processing threads on many interconnected processors. Storage memory can also become large for the same reasons.

Data processing platform 100 includes host random access memory (RAM) 105 connected to host processor 110, typically through an integrated memory controller. The memory of accelerator module 120 can be host-mapped as part of system memory in addition to random access memory (RAM) 105, or exist as a separate shared memory pool. The CCIX protocol is employed with data processing platform 100 to provide expanded memory capabilities, including functionality provided herein, in addition to the acceleration and cache coherency capabilities of CCIX.

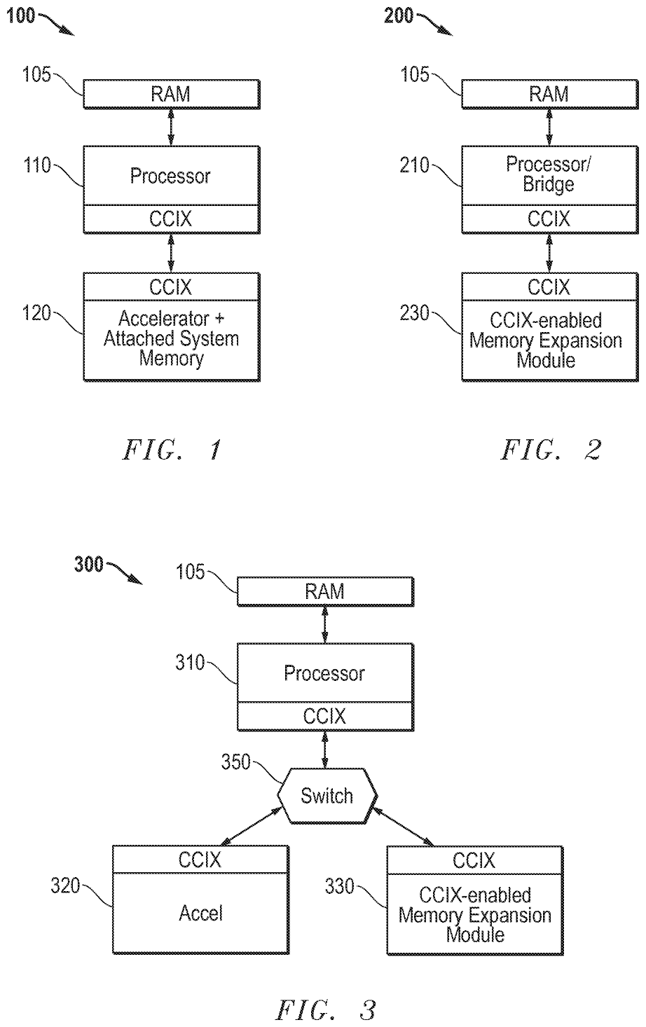

FIG. 2 illustrates in block diagram form a data processing platform 200 with another simple topology for CCIX applications. Data processing platform 200 includes a host processor 210 connected to host RAM 105. Host processor 210 communicates over a bus through a CCIX interface to a CCIX-enabled expansion module 230 that includes memory. Like the embodiment of FIG. 1, the memory of expansion module 230 can be host-mapped as part of system memory. The expanded memory capability may offer expanded memory capacity or allow integration of new memory technology beyond that which host processor 210 is capable of directly accessing, both with regard to memory technology and memory size.

FIG. 3 illustrates in block diagram form a data processing platform 300 with a switched topology for CCIX applications. Host processor 310 connects to a CCIX-enabled switch 350, which also connects to an accelerator module 320 and a CCIX-enabled memory expansion module 330. The expanded memory capabilities and capacity of the prior directly-connected topologies are provided in data processing platform 300 by connecting the expanded memory through switch 350.

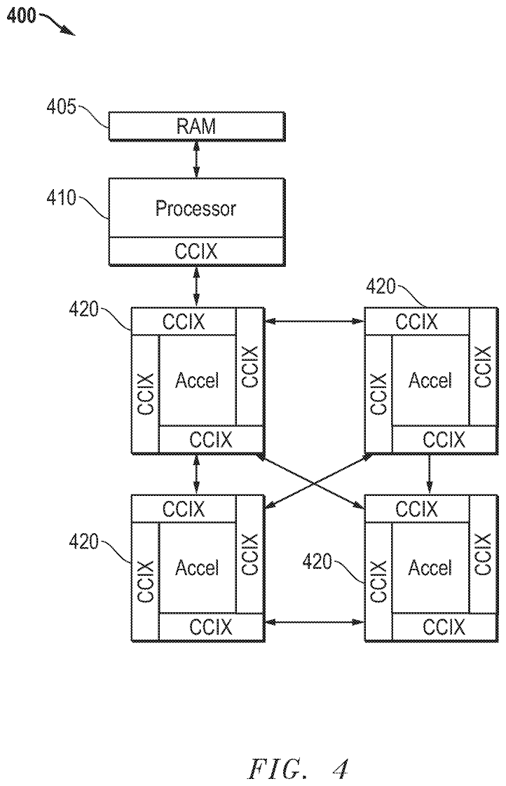

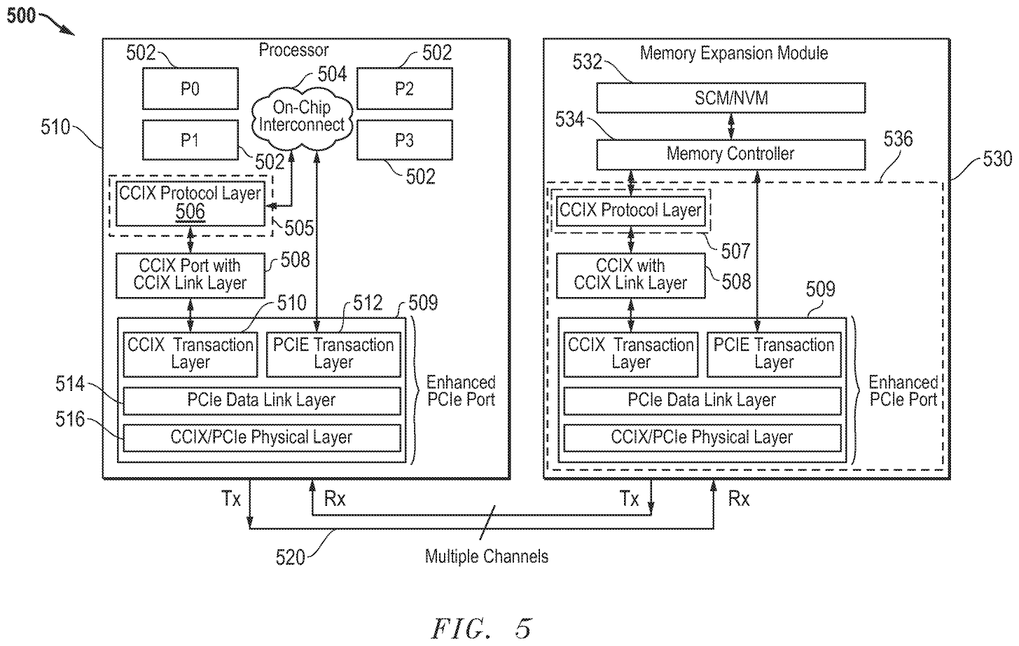

FIG. 4 illustrates in block diagram from a data processing platform 400 according to another exemplary topology for CCIX applications. Host processor 410 is linked to a group of CCIX accelerators 420, which are nodes in a CCIX mesh topology as depicted by the CCIX links between adjacent pairs of nodes 420. This topology allows computational data sharing across multiple accelerators 420 and processors. In addition, platform 400 may be expanded to include accelerator-attached memory, allowing shared data can to reside in either host RAM 105 or accelerator-attached memory.

While several exemplary topologies are shown for a data processing platform, the techniques herein may be employed with other suitable topologies including mesh topologies.

FIG. 5 illustrates in block diagram from a design of an exemplary data processing platform 500 configured according to the topology of FIG. 2. Generally, host processor 510 connects to an expansion module 530 over a CCIX interface. While a direct, point-to-point connection is shown in this example, this example is not limiting, and the techniques herein may be employed with other topologies employing CCIX data processing platforms, such as switched connections, and other data processing protocols with packet-based communication links. Host processor 510 includes four processor cores 502, connected by an on-chip interconnect network 504. The on-chip interconnect links each processor to an I/O port 509, which in this embodiment is a PCIe port enhanced to include a CCIX transaction layer 510 and a PCIE transaction layer 512. I/O port 509 provides a CCIX protocol interconnect to expansion module 530 that is overlaid on a PCIe transport on PCIe bus 520. PCIe bus 520 may include multiple lanes such as one, four, eight, or sixteen lanes, each lane having two uni-directional serial links, one link dedicated to transmit and one to receive. Alternatively, similar bus traffic may be carried over transports other than PCIe.

In this example using CCIX over a PCIe transport, the PCIe port is enhanced to carry the serial, packet based CCIX coherency traffic while reducing latency introduced by the PCIe transaction layer. To provide such lower latency for CCIX communication, CCIX provides a light weight transaction layer 510 that independently links to the PCIe data link layer 514 alongside the standard PCIe transaction layer 512. Additionally, a CCIX link layer 508 is overlaid on a physical transport like PCIe to provide sufficient virtual transaction channels necessary for deadlock free communication of CCIX protocol messages. The CCIX protocol layer controller 506 connects the link layer 508 to the on-chip interconnect and manages traffic in both directions. CCIX protocol layer controller 506 is operated by any of a number of defined CCIX agents 505 running on host processor 510. Any CCIX protocol component that sends or receives CCIX requests is referred to as a CCIX agent. The agent may be a Request Agent, a Home Agent, or a Slave agent. A Request Agent is a CCIX Agent that is the source of read and write transactions. A Home Agent is a CCIX Agent that manages coherency and access to memory for a given address range. As defined in the CCIX protocol, a Home Agent manages coherency by sending snoop transactions to the required Request Agents when a cache state change is required for a cache line. Each CCIX Home Agent acts as a Point of Coherency (PoC) and Point of Serialization (PoS) for a given address range. CCIX enables expanding system memory to include memory attached to an external CCIX Device. When the relevant Home Agent resides on one chip and some or all of the physical memory associated with the Home Agent resides on a separate chip, generally an expansion memory module of some type, the controller of the expansion memory is referred to as Slave Agent. The CCIX protocol also defines an Error Agent, which typically runs on a processor with another agent to handle errors.

Expansion module 530 includes generally a memory 532, a memory controller 534, and a bus interface circuit 536, which includes an I/O port 509, similar to that of host processor 510, connected to PCIe bus 520. Multiple channels or a single channel in each direction may be used in the connection depending on the required bandwidth. A CCIX port 508 with a CCIX link layer receives CCIX messages from the CCIX transaction layer of I/O port 509. A CCIX slave agent 507 includes CCIX protocol layer 506 and fulfills memory requests from CCIX agent 505. Memory controller 534 is connected to memory 532 to manage reads and writes under control of slave agent 507. Memory controller 534 may be integrated on a chip with some or all of the port circuitry of I/O port 509, or its associated CCIX protocol logic layer controller 506 or CCIX link layer 508, or may be in a separate chip. Expansion module 530 includes a memory 532 including at least one memory chip. In this example, the memory is a storage class memory (SCM) or a nonvolatile memory (NVM). However, these alternatives are not limiting, and many types of memory expansion modules may employ the techniques described herein. For example, a memory with mixed NVM and RAM may be used, such as a high-capacity flash storage or 3D crosspoint memory with a RAM buffer.

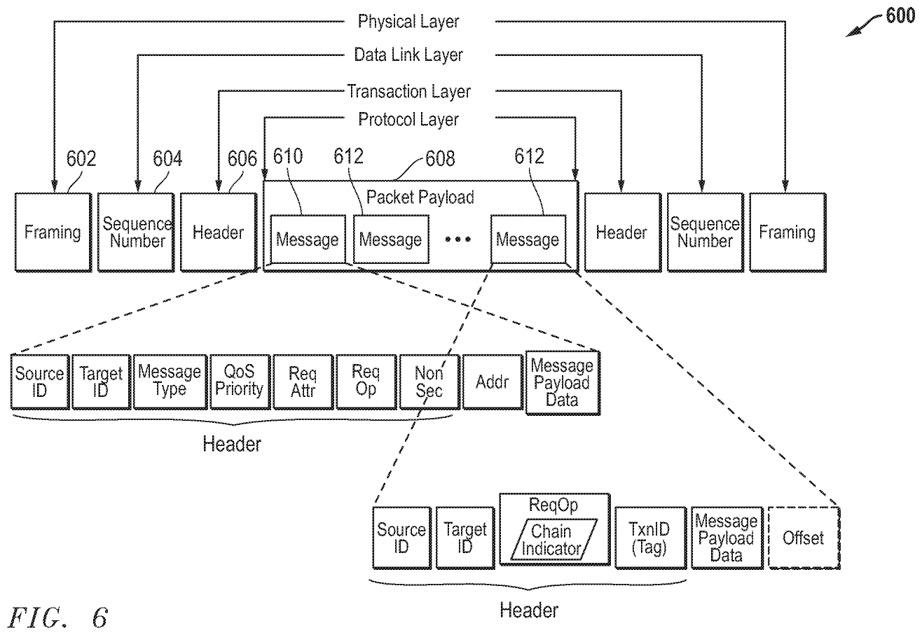

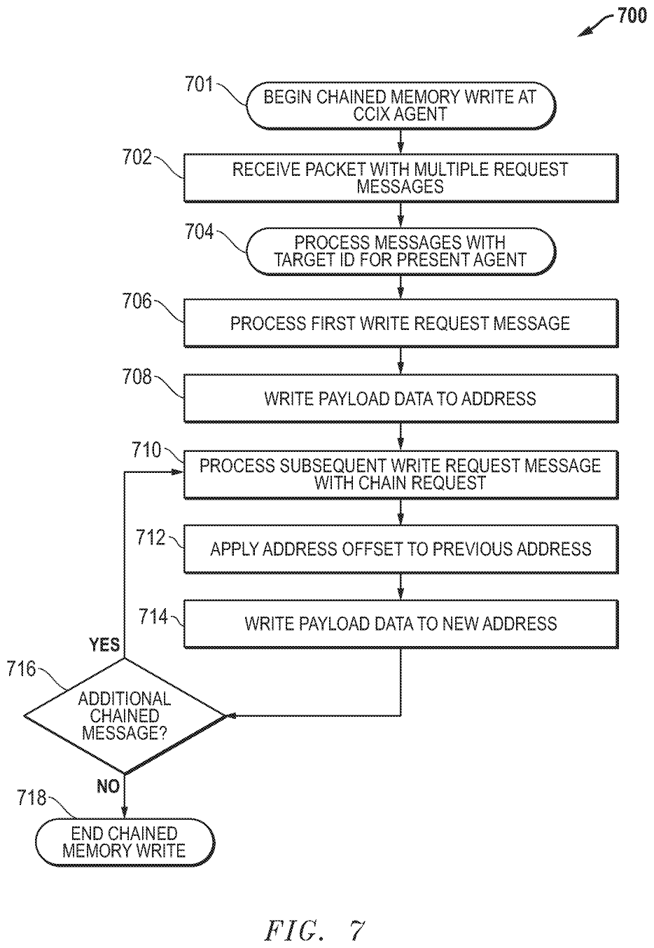

FIG. 6 shows in block diagram form a packet structure for chained memory request messages according to some embodiments. The depicted formats are used in communicating with memory expansion modules 130, 230, 330, 430, and 530 according to the exemplary embodiments herein. Packet 600 includes a payload 608 and control information provided at several protocol layers of the interconnect link protocol such as CCIX/PCIe. The physical layer adds framing information 602 including start and end delimiters to each packet. The data link layer puts the packets in order with a sequence number 604. The transaction layer adds a packet header 606 including various header information identifying the packet type, requestor, address, size, and other information specific to the transaction layer protocol. Payload 608 includes a number of messages 610, 612 formatted by the CCIX protocol layer. The messages 610, 612 are extracted and processed at their target recipient CCIX agent at the destination device by the CCIX protocol layer.

Message 610 is a CCIX protocol message with a full-size message header. Messages 612 are chained messages having fewer message fields than message 610. The chained messages allow an optimized message to be sent for a request message 612 indicating it is directed to the subsequent address of a previous request message 610. Message 610 includes the message payload data, an address, and several message fields, further set forth in the CCIX standard ver. 1.0, including a Source ID, a Target ID, a Message Type, a Quality of Service (QoS) priority, a Request Attribute (Req Attr), a Request Opcode (ReqOp), a Non-Secure region (NonSec) bit, and an address (Addr). Several other fields may be included in CCIX message headers of messages 610 and 612, but are not pertinent to the message chaining function and are not shown.

A designated value for the request opcode indicating a request type of “ReqChain,” is used to indicate a chained request 612. The chained requests 612 do not include the Request Attribute, address, Non-Secure region, or Quality of Service priority fields, and the 4B aligned bytes containing these fields are not present in the chained request messages. These fields, except address, are all implied to be identical to the original request 610. The Target ID and Source ID fields of a chained Request are identical to the original Request. The Transmission ID (TxnID) field, referred to as a tag, provides a numbered order for a particular chained request 612 relative to the other chained requests 612. The actual request opcode of the chained requests 612 is interpreted by the receiving agent to be identical to the original request 610, because the request opcode value indicates a chained request 612. The address value for each chained message 612 is obtained by adding 64 for 64B cache line or 128 for 128B cache line to the address of previous Request in the chain. Alternatively, chained message 612 may optionally include an offset field as depicted in the diagram by the dotted box. The offset stored in the offset field may provide for a different offset value than the 64B or 128B provided by default cache line sizes, allowing specific portions of data structures to be altered in chained requests. The offset value may also be negative.

It is permitted to interleave non-Request messages, such as Snoop or Response message, between chained Requests. The address field of any Request might be required by a later Request that might be chained to the earlier Request. In some embodiments, request chaining is only supported for all requests which are cache line sized accesses, and have accesses aligned to cache line size. In some embodiments, a chained Request can only occur within the same packet. In other embodiments, chained requests are allowed to span multiple packets, with ordering accomplished through the transmission ID field.

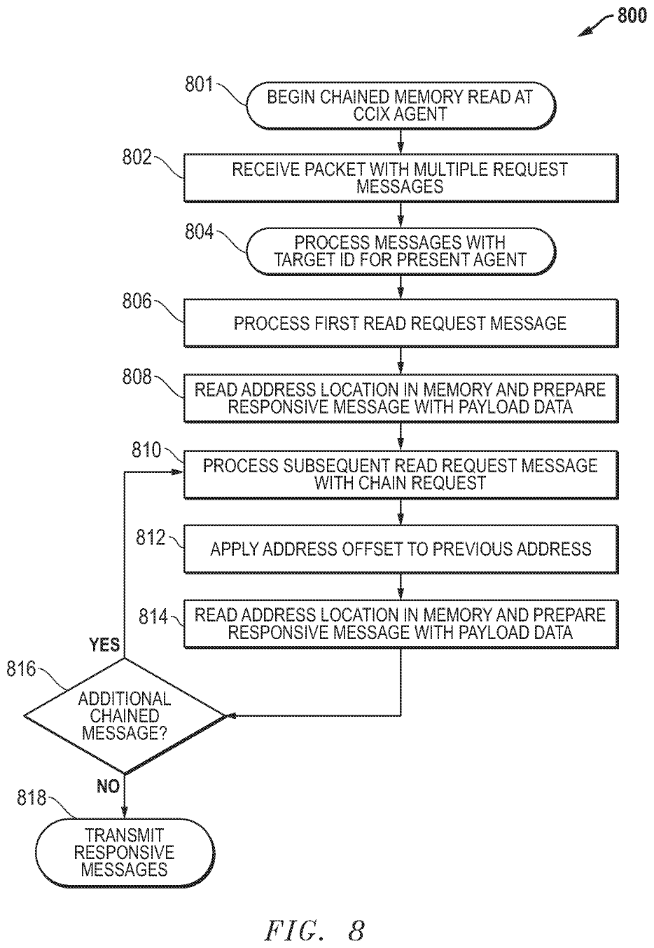

FIG. 7 shows in flow diagram form a process 700 for fulfilling chained memory write requests according to some embodiments. A chained memory write process 700 is begun at block 701 by a memory expansion module including a CCIX slave agent such as agent 507 of FIG. 5. While in this example a memory expansion module performs the chained memory write, a host processor or an accelerator module such as those in the examples above may also fulfill write and read chained memory requests. The chained requests are typically prepared and transmitted by a CCIX master agent or home agent, which may be executed in firmware on a host processor or accelerator processor.

Process 700 is generally performed by a CCIX protocol layer such as, for example, CCIX protocol layer 506 (FIG. 5) executing on bus interface circuit 536 in cooperation with memory controller 534. While a particular order is shown, the order is not limiting, and many of the steps may be performed in parallel for many chained messages. At block 702, process 700 receives a packet 608 (FIG. 6) with multiple request messages. At block 704, the messages with a target ID for slave agent 507 begin processing. The first message is a full memory write request like request 610, and is processed first at block 706, providing message field data and address information providing the basis for interpreting the later chained messages 612. The first write message is processed by extracting and interpreting the message fields. In response to the first message, the payload data is written in memory, such as memory 532, at the location indicated by the address designated in the message, at block 708.

The first chained request message 612 is processed at block 710. The chaining indicator is recognized by the CCIX protocol layer, which responds by providing the values for those message fields not present in chained requests (Request Attribute, Non-Secure region, Address, and Quality of Service priority fields). These values, except the address value, are provided from the first message 610 processed at block 706. At block 712, for each of the chained messages 612, the address value is provided by applying the offset value to the address from the first message 610, or the address from the prior chained message as indicated by the message order provided by the Transmission ID field. Process 700 then stores the payload data for the current message in the memory at locations indicated by the calculated address at block 714.

Process 700 continues to process chained messages as long as chained messages are present in the received packet as indicated at block 716. If no more chained messages are present, the process for a chained memory write ends at block 718. For embodiments in which chained messages may span multiple packets, a flag or other indicator such as a particular value of the Transmission ID field, may be employed to identify the final message in the chain. Positive acknowledgement messages may be sent in response to each fulfilled message. Because message processing is pipelined, acknowledgements may not necessarily be provided in the order of the chained requests.

FIG. 8 shows in flow diagram form a process 800 for fulfilling chained memory read requests according to some embodiments. The chained memory read process 800 is begun at block 801, and may be executed by a memory expansion module, a host processor or an accelerator module as discussed above with regard to the write process. The chained read requests are typically prepared and transmitted by a CCIX master agent or home agent, which may execute on a host processor or accelerator processor.

Process 800, similarly to process 700, is generally performed by a CCIX protocol layer in cooperation with a memory controller. At block 802, process 800 receives a packet 608 (FIG. 6) with multiple request messages. The messages with a target ID for slave agent 507 begin processing at block 804. At block 806, the first read request message is processed by extracting and interpreting the message fields and address, providing the basis for interpreting the later chained messages 612. In response to the first message being interpreted as a read request for the designated address, at block 808 the location in the memory indicated by the address is read and a responsive message prepared with the read data. It should be noted that, while the process steps are depicted in a particular order, the actual read requests may all be pipelined independent of returning the responses, such that the memory controller may accomplish any particular process blocks out of order. Accordingly the responses may not necessarily be returned in request order.

The subsequent chained messages, chained to the first message, are then processed and fulfilled starting at block 810. For each of the subsequent chained messages, at block 812 the address value is provided by applying the offset value to the address from the first message, or the address from the prior chained message as indicated by the message order provided by the Transmission ID field. Process 800 then reads the memory 532 at the location indicated by the calculated address at block 814, and prepares a response message to the read request message containing the read data as payload data. Process 800 continues to process chained messages as long as chained messages are present in the received packet as indicated at block 816. If no more chained messages are present, the process for a chained memory read ends at block 818 and the responsive messages are transmitted. The responsive messages may be chained as well, in the same manner, to provide for more efficient communications overhead in both directions.

The enhanced PCIe port 609, and the CCIX agents 505, 507, and bus interface circuit 536 or any portions thereof may be described or represented by a computer accessible data structure in the form of a database or other data structure which can be read by a program and used, directly or indirectly, to fabricate integrated circuits. For example, this data structure may be a behavioral-level description or register-transfer level (RTL) description of the hardware functionality in a high-level design language (HDL) such as Verilog or VHDL. The description may be read by a synthesis tool which may synthesize the description to produce a netlist including a list of gates from a synthesis library. The netlist includes a set of gates that also represent the functionality of the hardware including integrated circuits. The netlist may then be placed and routed to produce a data set describing geometric shapes to be applied to masks. The masks may then be used in various semiconductor fabrication steps to produce the integrated circuits. Alternatively, the database on the computer accessible storage medium may be the netlist (with or without the synthesis library) or the data set, as desired, or Graphic Data System (GDS) II data.

The techniques herein may be used, in various embodiments, with any suitable products (e.g.) that requires processors to access memory over packetized communication links rather than typical RAM memory interfaces. Further, the techniques are broadly applicable for use data processing platforms implemented with GPU and CPU architectures or ASIC architectures, as well as programmable logic architectures.

While particular embodiments have been described, various modifications to these embodiments will be apparent to those skilled in the art. For example, the front-end controllers and memory channel controllers may be integrated with the memory stacks in various forms of multi-chip modules or vertically constructed semiconductor circuitry. Different types of error detection and error correction coding may be employed.

Accordingly, it is intended by the appended claims to cover all modifications of the disclosed embodiments that fall within the scope of the disclosed embodiments.

1. An apparatus comprising:
a memory with at least one memory chip;
a memory controller coupled to the memory; and
a bus interface circuit coupled to the memory controller and adapted to send and receive data on a data bus;
the memory controller and bus interface circuit together adapted for:
receiving a plurality of request messages over the data bus, wherein the bus interface circuit is adapted to receive the plurality of request messages inside a packet received over the data bus;
within a selected first one of the request messages, receiving a source identifier, a target identifier, a first address for which memory access is requested, and first payload data;
storing the first payload data in the memory at locations indicated by the first address;
within a selected second one of the request messages, receiving a chaining indicator associated with the first request message, and second payload data, the second request message including no address for which memory access is requested;
based on the chaining indicator, calculating a second address for which memory access is requested based on the first address; and
storing the second payload data in the memory at locations indicated by the second address.

2. (canceled)

3. The apparatus of claim 1, wherein the memory controller and bus interface circuit together are adapted for receiving multiple request messages subsequent to the second request message, and for respective ones of the subsequent messages, identifying respective chaining indicators and calculating respective subsequent addresses for which memory access is requested based on the first address.

4. The apparatus of claim 3, wherein the second and subsequent request messages include a transaction identifier indicating an order in which the second and subsequent addresses are to be calculated.

5. The apparatus of claim 1, wherein:
the memory controller is adapted to selectively process the first and second request messages; and
the first and second request messages are non-adjacent within the packet.

6. The apparatus of claim 1, wherein the data bus is compliant with the Cache Coherent Interconnect for Accelerators (CCIX) specification.

7. The apparatus of claim 1, wherein the memory controller is adapted to selectively process a subsequent request message chained to the first and second request messages, the subsequent request message received in a separate packet from the first and second request messages.

8. The apparatus of claim 1, wherein the second address is calculated based on a predetermined offset size of a cache line size.

9. The apparatus of claim 1, wherein the second address is calculated based on an offset size contained in the second request message.

10. A method comprising:
receiving a plurality of request messages over a data bus, wherein the plurality of request messages are included in a packet received over the data bus;
under control of a bus interface circuit, within a selected first one of the request messages, receiving a source identifier, a target identifier, a first address for which memory access is requested, and first payload data;
under control of a memory controller, storing the first payload data in a memory at locations indicated by the first address;
under control of the bus interface circuit, within a selected second one of the request messages, receiving a chaining indicator associated with the first request message and second payload data, the second request message including no address for which memory access is requested;
based on the chaining indicator, calculating a second address for which memory access is requested based on the first address; and
under control of the memory controller, storing the second payload data in the memory at locations indicated by the second address.

11. (canceled)

12. The method of claim 10, further comprising receiving multiple request messages subsequent to the second request message, and for respective ones of the subsequent messages, identifying respective chaining indicators and calculating respective subsequent addresses for which memory access is requested based on the first address.

13. The method of claim 12, wherein the second and subsequent request messages include a transaction identifier indicating an order in which the second and subsequent request message addresses are to be calculated.

14. The method of claim 10, further comprising selectively processing the first and second request messages, wherein the first and second request messages are non-adjacent within the packet.

15. The method of claim 10, wherein the data bus is compliant with the Cache Coherent Interconnect for Accelerators (CCIX) specification.

16. The method of claim 10, further comprising selectively processing a subsequent request message chained to the first and second request messages, the subsequent request message received in a separate packet from the first and second request messages.

17. The method of claim 10, wherein the second address is calculated based on a predetermined offset size of a cache line size.

18. The method of claim 10, wherein the second address is calculated based on an offset size contained in the second request message.

19. A method comprising:
receiving a plurality of request messages over a data bus, wherein the plurality of request messages are included in a packet received over the data bus;
under control of a bus interface circuit, within a selected first one of the request messages, receiving a source identifier, a target identifier, and a first address for which memory access is requested;
under control of the bus interface circuit, transmitting a reply message containing first payload data from locations in a memory indicated by the first address;
under control of the bus interface circuit, within a selected second one of the request messages, receiving a chaining indicator associated with the first request message, the second request message including no address for which memory access is requested;
based on the chaining indicator, calculating a second address for which memory access is requested based on the first address; and
under control of the bus interface circuit, transmitting a second reply message containing second payload data from locations in the memory indicated by the second address.

20. (canceled)

21. The method of claim 19, further comprising receiving multiple request messages subsequent to the second request message, and for respective ones of the subsequent messages, identifying respective chaining indicators and calculating respective subsequent addresses for which memory access is requested based on the first address.

22. The method of claim 21, wherein the second and subsequent request messages include a transaction identifier indicating an order in which the second and subsequent request message addresses are to be calculated.

23. The method of claim 21, further comprising selectively processing the first and second request messages, wherein the first and second request messages are non-adjacent within the packet.

24. The method of claim 19, wherein the data bus is compliant with the Cache Coherent Interconnect for Accelerators (CCIX) specification.

25. The method of claim 19, further comprising selectively processing a subsequent request message chained to the first and second request messages, the subsequent request message received in a separate packet from the first and second request messages.

26. The method of claim 19, wherein the second address is calculated based on a predetermined offset size of a cache line size.

27. The method of claim 19, wherein the second address is calculated based on an offset size contained in the second request message.

28. A system comprising:
a memory module including a memory with at least one memory chip, a memory controller coupled to the memory, and a first bus interface circuit coupled to the memory controller and adapted to send and receive data on a bus, the memory controller and the first bus interface circuit together adapted for:
receiving a plurality of request messages over the data bus, wherein the first bus interface circuit is adapted to receive the plurality of request messages inside a packet received over the data bus;
within a selected first one of the request messages, receiving a source identifier, a target identifier, a first address for which memory access is requested, and first payload data;
storing the first payload data in the memory at locations indicated by the first address;
within a selected second one of the request messages, receiving a chaining indicator associated with the first request message, and second payload data, the second request message including no address for which memory access is requested;
based on the chaining indicator, calculating a second address for which memory access is requested based on the first address; and
storing the second payload data in the memory at locations indicated by the second address; and
a processor including a second bus interface circuit coupled to the bus and configured to send the request messages over the data bus and receive responses.

29. (canceled)

30. The system of claim 28, wherein the memory controller and first bus interface circuit together are adapted for receiving multiple request messages subsequent to the second request message, and for respective ones of the subsequent messages, identifying respective chaining indicators and calculating respective subsequent addresses for which memory access is requested based on the first address.

31. The system of claim 30, wherein the second and subsequent request messages include a transaction identifier indicating an order in which the second and subsequent addresses are to be calculated.

32. The system of claim 31, wherein the memory controller is adapted to selectively process the first and second request messages, wherein the first and second request messages are non-adjacent within the packet.

33. The system of claim 28, wherein the data bus is compliant with the Cache Coherent Interconnect for Accelerators (CCIX) specification.

34. The system of claim 28, wherein the memory controller is adapted to selectively process a subsequent request message chained to the first and second request messages, the subsequent request message received in a separate packet from the first and second request messages.

35. The system of claim 28, wherein the second address is calculated based on a predetermined offset size of a cache line size.

36. The system of claim 28, wherein the second address is calculated based on an offset size contained in the second request message.
